(19) United States
(12) Patent Application Publication
(10) Pub. No.: US 2009/0211702 A1
(43) Pub. Date: Aug. 27, 2009

(54) Film extrusion method

(76) Inventors: Tony J. Aguiar, Oakville (CA); Malcolm Ward, Bradford (CA)

Correspondence Address: CLARK HILL, P.C., 500 WOODWARD AVENUE, SUITE 3500, DETROIT, MI, 48226, US

(21) Appl. No.: 12/072,258

(22) Filed: Feb. 25, 2008

(51) Int. Cl. C09J 5/06

(52) U.S. Cl. 156/320

(57) ABSTRACT

A method of applying a film, including a top layer having a softening point temperature and an adhesive tie layer, to an extruded substrate having a receiving surface to form a finished extrusion is provided including the steps of heating the adhesive tie layer of the film, heating the extruded substrate, placing the adhesive tie layer of the film in contact with the receiving surface of the extruded substrate, applying a predetermined force to the film to bond the adhesive tie layer to the extruded substrate and form the finished extrusion, and maintaining the top layer of the film at a temperature below the softening point temperature to prevent the top layer from being marred as the adhesive tie layer bonds to the extruded substrate.

The invention relates to a method for applying a film to an extruded substrate to form a finished extrusion.

### SUMMARY

According to one aspect of the invention, a method for applying a film to an extruded substrate to form a finished extrusion includes the steps of heating an adhesive tie layer of the film, heating the extruded substrate, placing the adhesive tie layer of the film in contact with a receiving surface of the extruded substrate, applying a predetermined force to the film to bond the adhesive tie layer to the extruded substrate and form the finished extrusion, and maintaining a top layer of the film at a temperature below a softening point temperature to prevent the top layer from being marred as the adhesive tie layer bonds to the extruded substrate.

According to another aspect of the invention, a method for applying a film to an extruded substrate to form a finished extrusion includes the steps of heating the adhesive tie layer to a temperature of at least 180° C., heating the extruded substrate, placing the adhesive tie layer of the film in contact with a receiving surface of the extruded substrate; applying a predetermined force to the film to bond the adhesive tie layer to the extruded substrate and form the finished extrusion, and maintaining a top layer of the film at a temperature below a softening point temperature to prevent the top layer from being marred as the adhesive tie layer bonds to the extruded substrate.

According to still another aspect of the invention, a method for applying a film to an extruded substrate to form a finished extrusion includes the steps of feeding the extruded substrate into a tool at a first entry point, feeding the film into the tool at a second entry point through a chute, heating the adhesive tie layer of the film as the film moves through the chute, heating the extruded substrate, placing the adhesive tie layer of the film into contact with a receiving surface of the extruded substrate, activating an application shoe to apply a predetermined force to the film in order to bond the adhesive tie layer to the extruded substrate, and maintaining a top layer at a temperature below a softening point temperature of the top layer to prevent the top layer from being marred as the adhesive tie layer bonds to the extruded substrate.

### BRIEF DESCRIPTION OF THE DRAWING

The invention will be readily appreciated as the same becomes better understood by reference to the following detailed description when considered in connection with the accompanying drawings wherein:

FIG. 1 is a fragmentary perspective view of a tool utilized for bonding a film to an extruded substrate to form a finished extrusion.

### DETAILED DESCRIPTION OF THE EMBODIMENTS

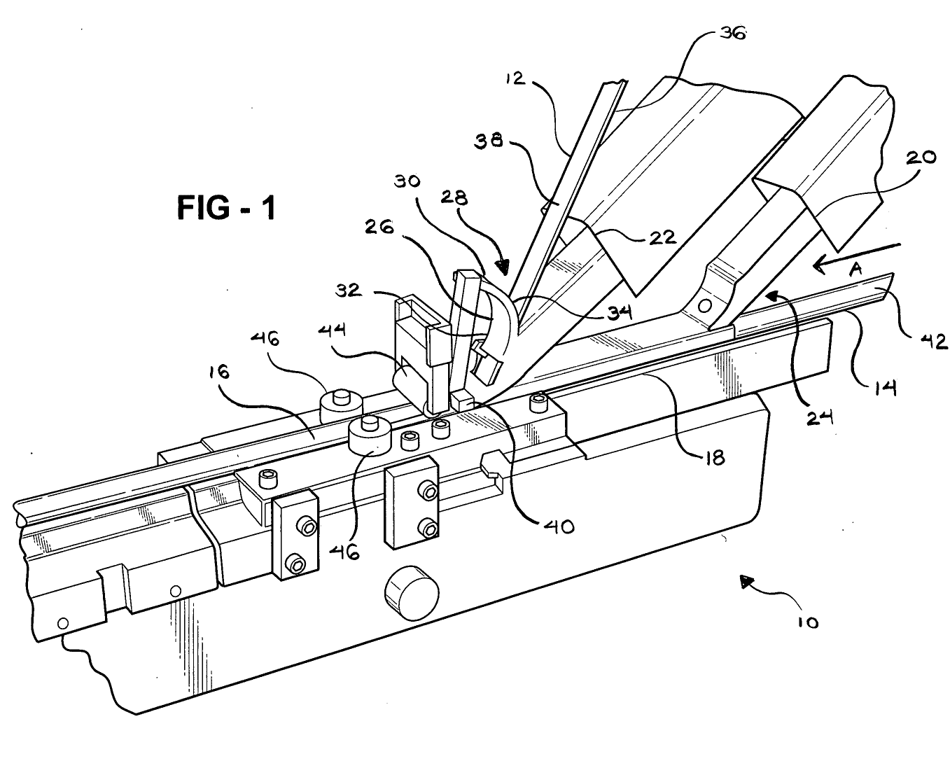

Referring to FIG. 1, a tool, generally shown at 10, is provided for bonding a film 12 to an extruded substrate 14 to form a finished extrusion 16. The tool 10 includes a main conveyor 18 that provides linear movement of the extruded substrate 14 in the direction of arrow A.

The tool 10 includes a first heat delivery unit 20 and a second heat delivery unit 22 spaced apart from one another along the main conveyor 18. The first heat delivery unit 20 provides super heated air to the extruded substrate 14 proximate a first entry point 24. The first heat delivery unit 20 heats the extruded substrate 14 sufficiently such that the extruded substrate 14 retains ample heat energy to facilitate bonding between the extruded substrate 14 and the film 12. It is appreciated that the temperature to which the extruded substrate 14 is heated will depend upon the application rate of the extruded substrate 14.

The second heat delivery unit 22 is disposed adjacent a chute 26 which receives the film 12 therewithin at a second entry point 28. The film 12 is heated with super heated air from the second heat delivery unit 22 while the film 12 is in the chute 26. The chute 26 includes an upper end 30, a lower end 32, and a guiding surface 34 extending between the upper 30 and lower 32 ends. The guiding surface 34 guides the film 12 in a downward direction towards the extruded substrate 14.

The film 12 includes an adhesive tie layer 36 at a bottom surface, a top layer 38 at a top surface, and a color matched layer between the adhesive tie 36 and top 38 layers. The top layer 38 may be clear, transparent, or translucent. The film 12 can, therefore, be matched to the appearance of a typical paint finish for motor vehicles. The second heat delivery unit 22 heats the adhesive tie layer 36 at the bottom surface of the film 12. In one embodiment, the adhesive tie layer 36 is heated to a temperature of at least 180° C. It is, however, appreciated that in other embodiments the adhesive tie layer 36 is heated to a temperature of at least approximately 180° C.

The top layer 38 melts, however, at a much lower temperature than the adhesive tie layer 36. Specifically, a softening point temperature of the top layer 38 varies between approximately 70° C. and 140° C. depending upon the application rate of the film 12 to the extruded substrate 14. Therefore, the top layer 38 of the film 12 must be maintained at a lower temperature while the adhesive tie layer 36 is heated in order to prevent surface defects, such as marring, gloss reduction, rough or pinched edges, and areas of non-bonding, along the top layer 38 of the film 12 during the bonding process. As a result, the finished extrusion 16 will have a Class A finish suitable for all motor vehicles.

An application shoe 40 is proximate the chute 26 to place the heated adhesive tie layer 36 of the film 12 into contact with the receiving surface 42 of the heated extruded substrate. The application shoe 40 applies a predetermined force to the film 12 to bond the heated adhesive tie layer 36 to the extruded substrate 14 and form the finished extrusion 16. In addition, the application shoe 40 has a predetermined contour and shape to align the film 12 with the extruded substrate 14 and guide the film 12 thereon. The application shoe 40 is cooled to regulate its temperature. Such cooling is needed to prevent marring of the top layer 38 of the film 12 which, as noted above, is temperature-sensitive. Also, without cooling the temperature of the application shoe 40 would rise to a level such that drag between the application shoe 40 and the film 12 would increase, thereby causing the film 12 to stretch and break.

A top roller 44 and side rollers 46 are provided to further guide the film 12 upon exiting the application shoe 40. The top roller 44 and side rollers 46 use a controlled force to apply pressure on the finished extrusion 16 to further bond the adhesive tie layer 36 to the extruded substrate 14. It is contemplated that although only one top roller 44 and one pair of side rollers 46 are disclosed, any number of additional rollers may be provided for further guiding and bonding. Optionally, the finished extrusion 16 may be cooled after exiting the rollers 44, 46. The amount of cooling that is required will depend upon the application rate, ambient conditions, and application temperatures.

The extruded substrate 14 is formed from one of numerous materials including, but not limited to, polypropylene, polyethylene, or thermoplastic olefinic elastomer (TPO).

The finished extrusion 16 may be formed for use in any of numerous applications including, but not limited to, roof ditch moldings for motor vehicles.

In one embodiment, a method for applying the film 12 to the extruded substrate 14 to form the finished extrusion 16 begins with the step of heating the extruded substrate 14 to a predetermined temperature by the first heat delivery unit 20. The adhesive tie layer 36 of the film 12 is heated by the second heat delivery unit 22. In an embodiment, the adhesive tie layer 36 is heated above a temperature of at least approximately 180° C. The film 12 is guided by the chute 26 towards the extruded substrate 14. The application shoe 40 aligns the film 12 with the extruded substrate 14, and places the adhesive tie layer 36 of the film 12 into contact with the receiving surface 42 of the extruded substrate 14. The application shoe 40 applies a predetermined force to the film 12 to bond the adhesive tie layer 36 to the extruded substrate 14 in order to form the finished extrusion 16. The top layer 38 of the film 12 is maintained at a temperature below its softening point temperature to prevent the top layer 38 from being marred as the adhesive tie layer 36 bonds to the extruded substrate 14. The top roller 44 and side rollers 46 apply pressure to the finished extrusion 16 to promote further bonding of the adhesive tie layer 36 to the extruded substrate 14.

In another embodiment of a method for applying the film 12 to the extruded substrate 14 to form the finished extrusion 16, the extruded substrate 14 is introduced to the tool 10 at the first entry point 24 and the film 12 is introduced to the tool 10 at the second entry point 26. The extruded substrate 14 is heated to a predetermined temperature by the first heat delivery unit 20. And the adhesive tie layer 36 of the film 12 is heated by the second heat delivery unit 22 to a temperature of at least 180° C. The film 12 is guided by the chute 26 towards the extruded substrate 14. The application shoe 40 places the adhesive tie layer 36 of the film 12 into contact with the receiving surface 42 of the extruded substrate 14. The application shoe 40 applies a predetermined force to the film 12 to bond the adhesive tie layer 36 to the extruded substrate 14 in order to form the finished extrusion 16. The top layer 38 of the film 12 is maintained at a temperature below its softening point temperature to prevent the top layer 38 from being marred as the adhesive tie layer 36 bonds to the extruded substrate 14. The top roller 44 and side rollers 46 apply pressure to the finished extrusion 16 to promote further bonding of the adhesive tie layer 36 to the extruded substrate 14.

In yet another embodiment, a method for applying the film 12 to the extruded substrate 14 to form the finished extrusion 16 begins with the steps of introducing the extruded substrate 14 to the tool 10 at the first entry point 24 and introducing the film 12 to the tool 10 at the second entry point 26. The extruded substrate 14 is heated to a predetermined temperature by the first heat delivery unit 20. And the adhesive tie layer 36 of the film 12 is heated by the second heat delivery unit 22. In one embodiment, the adhesive tie layer 36 is heated to a temperature of at least 180° C. In another embodiment, the adhesive tie layer 36 is heated to a temperature of at least approximately 180° C. The film 12 is guided by the chute 26 towards the extruded substrate 14. The application shoe 40 places the adhesive tie layer 36 of the film 12 into contact with the receiving surface 42 of the extruded substrate 14. The application shoe 40 applies a predetermined force to the film 12 to bond the adhesive tie layer 36 to the extruded substrate 14 in order to form the finished extrusion 16. The top layer 38 of the film 12 is maintained at a temperature below its softening point temperature to prevent the top layer 38 from being marred as the adhesive tie layer 36 bonds to the extruded substrate 14. The top roller 44 and side rollers 46 apply pressure to the finished extrusion 16 to promote further bonding of the adhesive tie layer 36 to the extruded substrate 14.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A method of applying a film, including a top layer having a softening point temperature and an adhesive tie layer, to an extruded substrate having a receiving surface to form a finished extrusion, the method comprising the steps of:
heating the adhesive tie layer of the film;
heating the extruded substrate;
placing the adhesive tie layer of the film in contact with the receiving surface of the extruded substrate;
applying a predetermined force to the film to bond the adhesive tie layer to the extruded substrate and form the finished extrusion; and
maintaining the top layer of the film at a temperature below the softening point temperature to prevent the top layer from being marred as the adhesive tie layer bonds to the extruded substrate.

2. A method as set forth in claim 1 wherein the step of placing the adhesive tie layer of the film in contact with the receiving surface of the extruded substrate includes the step of aligning the film with the extruded substrate to maximize bonding therebetween.

3. A method as set forth in claim 2 wherein the step of placing the adhesive tie layer of the film in contact with the receiving surface of the extruded substrate includes the step of shaping the film to fit the extruded substrate.

4. A method as set forth in claim 3 including the step of applying pressure to the finished extrusion with a roller to further bond the adhesive tie layer to the extruded substrate.

5. A method as set forth in claim 4 including the step of varying the softening point temperature of the top layer based on the rate at which the film is applied to the extruded substrate.

6. A method as set forth in claim 5 including the step of cooling the top layer of the film subsequent to the step of applying a predetermined force to the film to bond the adhesive tie layer to the extruded substrate and form the finished extrusion.

7. A method as set forth in claim 1 wherein the step of placing the adhesive tie layer of the film in contact with the receiving surface of the extruded substrate occurs subsequent to the steps of heating the adhesive tie layer of the film and heating the extruded substrate.

8. A method as set forth in claim 1 wherein the step of maintaining the top layer of the film at a temperature below the softening point temperature to prevent the top layer from being marred as the adhesive tie layer bonds to the extruded substrate includes the step of keeping the temperature of the top layer below approximately 70° C.

9. A method as set forth in claim 1 wherein the step of maintaining the top layer of the film at a temperature below a softening point temperature of the top layer to prevent the top layer from being marred as the adhesive tie layer bonds to the extruded substrate includes the step of keeping the temperature of the top layer below approximately 140° C.

10. A method as set forth in claim 1 wherein the step of maintaining the top layer of the film at a temperature below a softening point temperature of the top layer to prevent the top layer from being marred as the adhesive tie layer bonds to the extruded substrate occurs simultaneous with the step of heating the adhesive tie layer of the film.

11. A method as set forth in claim 1 wherein the step of heating the adhesive tie layer of the film includes the step of heating the adhesive tie layer to a temperature of at least approximately 180° C.

12. A method of applying a film, including an adhesive tie layer and a top layer having a softening point temperature, to an extruded substrate to form a finished extrusion, the method comprising the steps of:
heating the adhesive tie layer to a temperature of at least 180° C.;
heating the extruded substrate;
placing the adhesive tie layer of the film into contact with the receiving surface of the extruded substrate;
applying a predetermined force to the film to bond the adhesive tie layer to the extruded substrate; and
maintaining the top layer of the film at a temperature below the softening point temperature to prevent the top layer from being marred as the adhesive tie layer bonds to the extruded substrate.

13. A method as set forth in claim 12 wherein the step of maintaining the top layer at a temperature below the softening point temperature to prevent the top layer from being marred as the adhesive tie layer bonds to the extruded is simultaneous with the step of applying a predetermined force to the film to bond the adhesive tie layer to the extruded substrate.

14. A method as set forth in claim 12 including the step of varying the softening point temperature of the top layer based on the rate at which the film is applied to the extruded substrate.

15. A method as set forth in claim 12 wherein the step of placing the adhesive tie layer of the film into contact with the receiving surface of the extruded substrate occurs subsequent to the steps of heating the adhesive tie layer and heating the extruded substrate.

16. A method of applying a film, including a top layer having a softening point temperature and an adhesive tie layer, to an extruded substrate to form a finished extrusion utilizing a tool having a first entry point, a second entry point, a chute at the second entry point, and an application shoe, the method comprising the steps of:
feeding the extruded substrate into the tool at the first entry point;
feeding the film through the chute and into the second entry point;
heating the adhesive tie layer of the film as the film moves through the chute;
heating the extruded substrate;
placing the heated adhesive tie layer of the film into contact with the heated extruded substrate;
activating the application shoe to apply a predetermined force to the film in order to bond the adhesive tie layer to the extruded substrate; and
maintaining the top layer at a temperature below the softening point temperature to prevent the top layer from being marred as the adhesive tie layer bonds to the extruded substrate.

17. A method as set forth in claim 16 wherein the step of maintaining the top layer at a temperature below the softening point temperature to prevent the top layer from being marred as the adhesive tie layer bonds to the extruded substrate is simultaneous with the step of heating the adhesive tie layer of the film as the film moves through the chute.

18. A method as set forth in claim 17 including the step of applying pressure to the finished extrusion with a roller to further bond the adhesive tie layer to the extruded substrate.

19. A method as set forth in claim 18 including the step of aligning the film with the extruded substrate to maximize bonding therebetween prior to the step of placing the adhesive tie layer of the film into contact with the receiving surface of the extruded substrate.

20. A method as set forth in claim 19 including the step of shaping the film to fit the extruded substrate prior to the step of placing the heated adhesive tie layer of the film into contact with the heated extruded substrate.

21. A method as set forth in claim 20 including the step of varying the softening temperature of the top layer based on the rate at which the film is applied to the extruded substrate.

22. A method as set forth in claim 21 wherein the step of activating the application shoe to apply a predetermined force to the film in order to bond the adhesive tie layer to the extruded substrate includes the step of cooling the application shoe.
